(19) United States
(12) Patent Application Publication
(10) Pub. No.: US 2009/0186777 A1
(43) Pub. Date: Jul. 23, 2009

(54) BIOCHIP HAVING INCREASED PROBE DENSITY

(75) Inventors: June-Young LEE, Gyeonggi-do (KR); Dong-Ho LEE, Gyeonggi-do (KR); Jae-Young KIM, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/357,270

(22) Filed: Jan. 21, 2009

(30) Foreign Application Priority Data
Jan. 23, 2008 (KR) 2008-0007241

(51) Int. Cl. C40B 40/04

(52) U.S. Cl. 506/15

(57) ABSTRACT

A biochip can include a substrate having surface features of protrusions or recesses and probes coupled to each of the surface features. A biochip can include a substrate having recess regions and probes coupled to each of the recess regions, wherein a surface of each of the recess regions has convexes and concaves. A biochip can include a substrate having recess regions, immobilization layers conformally formed in the recess regions, and probes coupled onto each of the immobilization layers. The biochip can be divided into probe cell regions to which the probes are coupled, wherein the recess regions are formed in the probe cell regions, and non-probe cell regions, wherein a surface of each of the non-probe cell regions can include an exposed surface of the substrate.

### CROSS-REFERENCE TO RELATED APPLICATIONS

This application claims priority to Korean Patent Application No. 10-2008-0007241, filed Jan. 23, 2008, the disclosure of which is incorporated herein by reference in its entirety.

### BACKGROUND

The technical field of the disclosed technology pertains to a biochip and, more particularly, to a biochip for analyzing the ingredients of a bio sample using a probe.

A representative example of a biochip is a micro array. A biochip generally provides a bio sample to a probe of a base immobilized on a substrate. One can observe the biochip to determine whether any reaction occurs between the probe and the bio sample in order to analyze the detailed ingredients of the bio sample. In a single bio chip, different probes of various types can be immobilized for each cell in order to allow data of various types to be read.

As the amount of data to be analyzed becomes larger and larger, increased integration of a biochip is needed. When increasing integration of a biochip, however, a reduction in the design rule of the biochip is often inevitable. The reduction in the design rule can lead to a reduction in an area occupied by a single probe cell, resulting in a reduction in the number of probes coupled to the probe cell. With the reduced number of probes, absolute detection strength, as required for analysis, is not easy to guarantee.

The need remains, therefore, for smaller biochips that allow for increased number of probes so that detection strength and sensitivity are improved.

### SUMMARY

The disclosed inventive concept generally comprises a biochip formed from a substrate, a plurality of surface features formed on the substrate, and a plurality of probes coupled to each of the plurality of surface features. The surface features are generally protrusions from or recesses in the substrate.

The disclosed technology can provide a biochip capable of increasing the number of probes coupled to each probe cell region.

The disclosed technology can also provide a biochip with increased detection strength.

Certain embodiments of the disclosed technology can provide a biochip that includes a substrate having surface protrusions, and probes coupled to each of the surface protrusions.

Certain other embodiments of the disclosed technology can provide a biochip that includes a substrate having recess regions, and probes coupled to each of the recess regions, wherein a surface of each of the recess regions has convexes and concaves.

### BRIEF DESCRIPTION OF THE DRAWINGS

Embodiments of the disclosed technology will become more apparent by describing in detail preferred embodiments thereof with reference to the attached drawings.

FIG. 1 illustrates a layout of a biochip according to various embodiments of the disclosed technology.

FIG. 2 is a cross-sectional view of a biochip according to a first embodiment of the disclosed technology.

FIG. 3 is a cross-sectional view of a biochip according to a second embodiment of the disclosed technology.

FIG. 4 is a cross-sectional view of a biochip according to a third embodiment of the disclosed technology.

FIG. 5 is a cross-sectional view of a biochip according to a fourth embodiment of the disclosed technology.

FIG. 6 is a cross-sectional view of a biochip according to a fifth embodiment of the disclosed technology.

FIG. 7 is a cross-sectional view of a biochip according to a sixth embodiment of the disclosed technology.

FIG. 8 is a cross-sectional view of a biochip according to a seventh embodiment of the disclosed technology.

FIGS. 9A through 9D are cross-sectional views of structures in interim processing stages to illustrate a method of fabricating the biochip illustrated in FIG. 2 according to the first embodiment of the disclosed technology.

FIGS. 10A through 10D are cross-sectional views of structures in interim processing stages to illustrate a method of fabricating the biochip illustrated in FIG. 4 according to the third embodiment of the disclosed technology.

FIGS. 11A through 11C are cross-sectional views of structures in interim processing stages to illustrate a method of fabricating the biochip illustrated in FIG. 8 according to the seventh embodiment of the disclosed technology.

### DETAILED DESCRIPTION OF EXAMPLE EMBODIMENTS

The disclosed technology may be understood more readily by reference to the following detailed description of various embodiments and the accompanying drawings. The disclosed technology may, however, be embodied in many different forms and should not be construed as being limited to the embodiments set forth herein. Rather, these embodiments are provided so that this disclosure will be thorough and complete and will fully convey various concepts of the disclosed technology to those skilled in the art, and the present invention will only be defined by the appended claims.

Accordingly, in order to avoid obscuring the invention, in some specific embodiments, well known processing steps, structures, techniques, materials or methods have not been described in detail.

It is noted that the use of any and all examples, or exemplary terms provided herein is intended merely to better illuminate the disclosed technology and is not a limitation on the scope of the invention unless otherwise specified. The use of the terms “a,” “an,” and “the” and similar referents in the context of describing the invention (especially in the context of the following claims) are to be construed to cover both the singular and the plural, unless otherwise indicated herein or clearly contradicted by context. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “comprising,” “having,” “including,” and “containing” are to be construed as open-ended terms (i.e., meaning “including, but not limited to,”) unless otherwise noted. As used herein the term “and/or” includes any and all combinations of one or more of the associated listed items.

The disclosed technology will be described with reference to perspective views, cross-sectional views, and/or plan views, in which various embodiments of the disclosed technology are shown. Thus, the profile of an exemplary view may be modified according to manufacturing techniques and/or allowances. That is, the described embodiments of the disclosed technology are not intended to limit the scope of the present invention but cover all changes and modifications that can be caused due to a change in manufacturing process. In the drawings, various components may be exaggerated or reduced for clarity. Like reference numerals refer to like elements throughout the specification.

Biochips according to certain embodiments of the disclosed technology generally analyze biomolecules contained in biological samples and are typically used in gene expression profiling, genotyping through detection of mutation or polymorphism (such as Single-Nucleotide Polymorphism (SNP), protein, or peptide assays), potential drug screening, and development and preparation of novel drugs, etc. Biochips can employ appropriate probes according to the kind of biological sample to be analyzed. Examples of probes suitable for biosensors generally include a DNA probe, a protein probe such as an antibody/antigen or a bacteriorhodopsin, a bacterial probe, a neuron probe, etc. A biosensor fabricated in the form of a chip may also be referred to as a biochip. For example, according to the kind of probe used, the biosensor may be referred to as a DNA chip, a protein chip, a cellular chip, a neuron chip, etc.

Biochips according to certain embodiments of the disclosed technology may include oligomer probes. The number of monomers contained in an oligomer probe is typically at an oligomer level. As used herein, the term “oligomer” generally refers to a low-molecular weight polymer molecule consisting of two or more covalently bound monomers. Oligomers typically have a molecular weight of about 1,000 or less, but the disclosed technology is not limited thereto. The oligomer may include about 2-500 monomers, or about 5-30 monomers.

The monomers can include nucleosides, nucleotides, amino acids, peptides, etc., according to the type of probe in the bio sample. In the disclosed technology, previously synthesized oligomer probes may be coupled to active regions, or oligomer probes may be synthesized on active regions by in-situ photolithography. As used herein, the terms “nucleosides” and “nucleotides” include not only known purine and pyrimidine bases, but can also include methylated purines or pyrimidines, acylated purines or pyrimidines, etc.

Furthermore, “nucleosides” and “nucleotides” as used herein can include not only known (deoxy)ribose, but also a modified sugar that contains a substitution of a halogen atom or an aliphatic group for at least one hydroxyl group or is functionalized with ether, amine, or the like.

As used herein, the term “amino acids” is intended to refer to not only naturally occurring, L-, D-, and nonchiral amino acids, but also to modified amino acids, amino acid analogs, etc.

As used herein, the term “peptides” generally refers to compounds produced by an amide bond between the carboxyl group of one amino acid and the amino group of another amino acid.

Unless otherwise specified in the following exemplary embodiments, the term “probe” refers to a DNA probe, which is typically an oligomer probe consisting of about 5-30 covalently bound monomers of necleotides. However, the disclosed technology is not limited to the probes listed above, and a variety of probes may used.

Embodiments of the disclosed technology will now be described with reference to the accompanying drawings. In the embodiments, surface features formed on or within substrate surfaces are generally either projections, rising above a planar elevation of the substrate, or a recess, formed as a cavity within the planar elevation of the substrate.

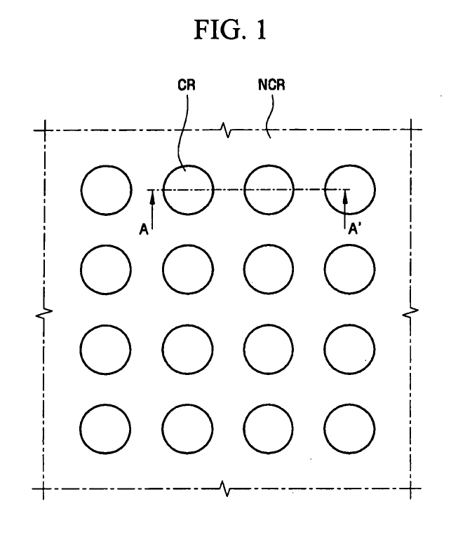

FIG. 1 illustrates a layout of a biochip according to various embodiments of the disclosed technology.

Referring to FIG. 1, a biochip according to embodiments of the disclosed technology includes probe cell regions CR to each of which a probe is coupled, and non-probe cell regions NCR to which probes are not coupled. The surface of each probe cell region CR may include a functional group capable of being coupled to a probe, and the surface of the non-probe cell regions NCR may not include a functional group capable of being coupled to a probe or may include a functional group that is rendered inactive by capping. In certain embodiments of the disclosed technology, the surface of the non-probe cell regions NCR may be an exposed substrate surface.

Probes of the same sequences are generally coupled and immobilized on a single probe cell region CR and the sequences of immobilized probes may vary over different probe cell regions CR. Different probe cell regions CR are separated from one another by the non-probe cell regions NCR. Thus, each probe cell region CR is separated such that it is independent from other probe cell regions CR, as it is surrounded by the non-probe cell regions NCR. Non-probe cell regions NCR may be connected to one another such that they are a single region. Multiple probe cell regions CR may be arranged in a matrix form. Although each probe cell region CR is illustrated in the shape of a circle in FIG. 1, various other shapes such as a rectangle, a square, a semi-circle, etc., can be implemented in alternative embodiments.

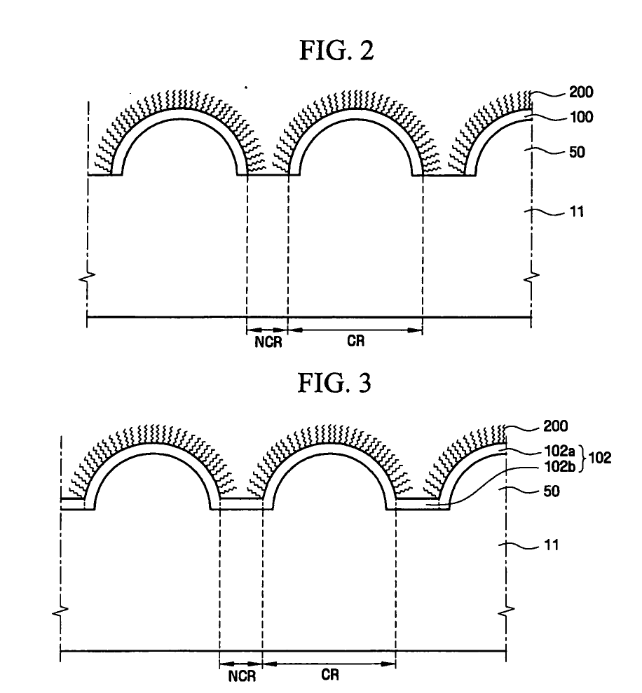

FIGS. 2 through 8 are cross-sectional views illustrating embodiments of a biochip fabricated using the layout of FIG. 1 taken along a line A-A′ of FIG. 1.

FIG. 2 is a cross-sectional view of a biochip according to a first embodiment of the disclosed technology.

Referring to FIG. 2, a biochip according to a first embodiment of the disclosed technology includes a substrate 11 having surface protrusions 50 and probes 200 coupled to each of the surface protrusions 50. The biochip may further include an immobilization layer 100 and/or a linker (not shown) (e.g., for mediating coupling between the probes 200 and the substrate 11).

In the example, the substrate 11 includes surface protrusions 50 and can be made of a material capable of minimizing (or zeroing) non-specific combination during a hybridization process. The substrate 11 can also be made of a material that is transparent to visible rays and/or ultraviolet (UV) rays. The substrate 11 can be either a flexible substrate or a rigid substrate. If a flexible substrate, the flexible substrate can be a nylon or nitrocellulose membrane or a plastic film. If a rigid substrate, the rigid substrate can be a silicon substrate or a transparent glass substrate such as soda lime glass. When using a silicon substrate or transparent glass substrate, almost no non-specific combination occurs during a hybridization process. A transparent glass substrate can be used for detection of a fluorescent material because of its transparency to visible rays and/or UV rays. A silicon substrate or a transparent glass substrate can allow the use of various thin-film fabricating processes and photo etching processes, which have been stably established and applied to a semiconductor device fabricating process or a liquid crystal display (LCD) panel fabricating process.

In the example, the surface protrusions 50 are formed on the substrate 11 to protrude above the substrate 11. In a biochip according to the first embodiment of the disclosed technology, the surface protrusions 50 and the substrate 11 are integrally formed. The surface protrusions 50 are formed only in probe cell regions CR of the biochip. The probes 200 may be coupled to each of the surface protrusions 50, and the immobilization layer 100 and/or a linker (not shown) may be interposed between the probes 200 and each of the surface protrusions 50. Since each of the surface protrusions 50 to which the probes 200 are coupled protrude above the substrate 11, an area to which the probes 200 can be coupled may be increased in comparison to a biochip to which the same design rule is applied. Thus, when compared to a biochip to which the same design rule is applied, a biochip according to the first embodiment of the disclosed technology can increase the number of probes 200 coupled to each probe cell region CR, thereby increasing the detection strength of a bio sample.

Although each of the surface protrusions 50 is illustrated as having a hemispherical shape in FIG. 2, various other shapes such as a horn shape, a tetrahedron pole, etc., can be implemented in alternative embodiments.

In the example, the immobilization layer 100 is conformally formed on each of the surface protrusions 50 and is coupled to the probes 200. The surface of the immobilization layer 100 includes a functional group that can be directly or indirectly coupled to the probes 200. As used herein, “direct coupling” of a functional group to the probes 200 generally refers to coupling of the functional group to the probes 200 without a medium between the functional group and the probes 200, and “indirect coupling” of a functional group to the probes 200 generally refers to coupling of the functional group to the probes 200 via a linker as a medium between the functional group and the probes 200.

In the example, the functional groups are groups that can be used as starting points for organic synthesis. That is, the functional groups are groups capable of coupling with (e.g., covalently or non-covalently binding with) the previously synthesized oligomer probes or the monomers (e.g., nucleosides, nucleotides, amino acids, or peptides) for in-situ synthesis of the oligomer probes. The functional groups are not limited to any particular functional groups, provided that they can be coupled to the previously synthesized oligomer probes or the monomers for in-situ synthesis of the oligomer probes. Examples of the functional groups can include hydroxyl groups, aldehyde groups, carboxyl groups, amino groups, amide groups, thiol groups, halo groups, and sulfonate groups.

In addition, the linker can have a functional group with a higher coupling reactivity to the probes 200 than the coupling reactivity of the functional group (e.g., SiOH) of the immobilization layer 100 to the probes 200. The linker can be formed of a material having a sufficient length to provide a spatial margin for a free interaction with a bio sample.

The immobilization layer 100 can be formed of a material that is substantially stable and is not hydrolyzed, in hybridization analysis condition (e.g., phosphate of pH 6-9), or a TRIS buffer. The immobilization layer 100 can also be formed of a material that can enable stable film formation on the substrate 11 and/or each of the surface protrusions 50, and can allow easy patterning during a semiconductor fabricating process or an LCD fabricating process.

The immobilization layer 100 can be made of a silicon oxide layer (such as a plasma enhanced-TEOS (PE-TEOS) layer, a high density plasma (HDP) oxide layer, a P—SiH₄ oxide layer, or a thermal oxide layer), a silicate such as hafnium silicate or zirconium silicate, a silicon nitride layer, a silicon oxynitride layer, a metal oxynitride layer (such as a hafnium oxynitride layer or a zirconium oxynitride layer), a metal oxide layer (such as a titanium oxide layer, a tantalum oxide layer, an aluminum oxide layer, a hafnium oxide layer, a zirconium oxide layer or an indium tin oxide (ITO) layer), a polyimide, a polyamine, a metal (such as gold, silver, copper or palladium), or a polymer such as polystyrene, polyacrylate, or polyvinyl.

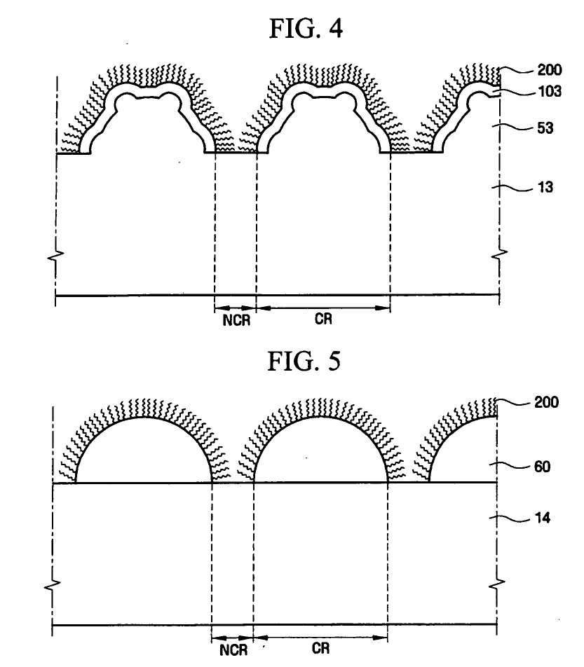

FIG. 3 is a cross-sectional view of a biochip according to a second embodiment of the disclosed technology.

Referring to FIG. 3, a biochip according to the second embodiment of the disclosed technology is different from a biochip according to the first embodiment of the disclosed technology in that an inactive region 102b of an immobilization layer 102 is formed on the surface of a non-probe cell region NCR.

In a biochip according to the second embodiment of the disclosed technology, the immobilization layer 102 includes an active region 102a and a non-active region 102b. The active region 102a is directly or indirectly coupled with probes 200 on its surface and the inactive region 102b is not coupled with the probes 200 on its surface. The inactive region 102b may include, for example, a functional group of the immobilization layer 102. The functional group may be rendered inactive by a capping group. The capping group may include a material that deactivates a functional group (such as SiOH) and a COH-group by, for example, acetylating the functional group in order to prevent the functional group from participating in chemical reactions.

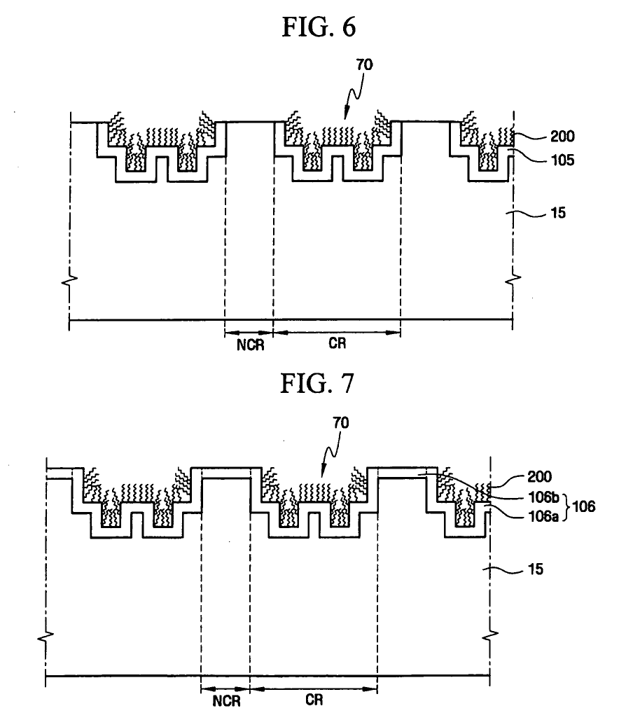

FIG. 4 is a cross-sectional view of a biochip according to a third embodiment of the disclosed technology.

Referring to FIG. 4, a biochip according to a third embodiment of the disclosed technology is different from a biochip according to the second embodiment of the disclosed technology in that the surface of a surface protrusion 53 formed to protrude above a substrate 13 includes concaves (e.g., concave portions of the surface protrusion 53) and convexes (e.g., convex portions of the surface protrusion 53).

More specifically, the surface protrusion 53 having concaves and convexes can be coupled with probes 200 via an immobilization layer 103 as a medium. Through such a structure, an area to which the probes 200 can be coupled can be increased relative to a biochip to which the same (or similar) design rule is applied. Thus, relative to a biochip to which the same (or similar) design rule is applied, a biochip according to the third embodiment of the disclosed technology can increase the number of probes 200 coupled to each probe cell region CR, thereby increasing the detection strength of a bio sample.

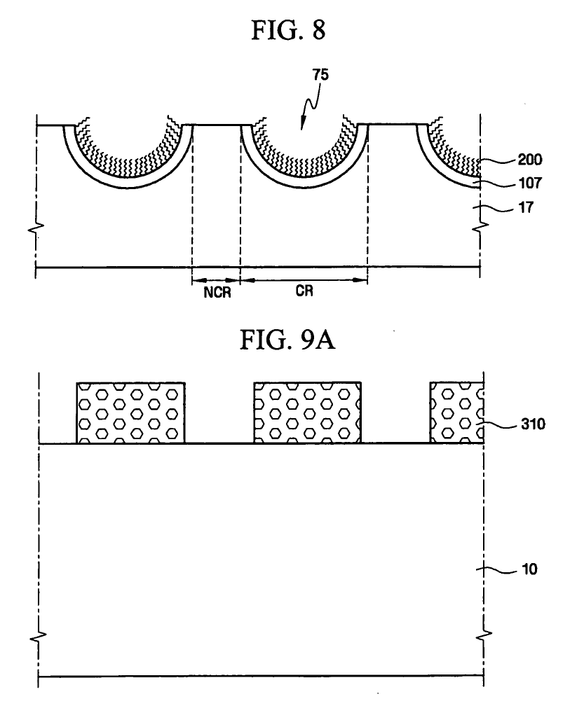

FIG. 5 is a cross-sectional view of a biochip according to a fourth embodiment of the disclosed technology.

Referring to FIG. 5, a biochip according to a fourth embodiment of the disclosed technology is different from a biochip according to the first embodiment of the disclosed technology in that a surface protrusion 60 and a substrate 14 are not integrally formed, and an immobilization layer (e.g., the immobilization layer 100 of FIG. 2) is not included.

More specifically, the surface protrusion 60 of a biochip according to the fourth embodiment of the disclosed technology can be formed to protrude above the substrate 14 and can include reflowed polymer. The reflowed polymer can be a material that includes a functional group capable of direct or indirect coupling to probes 200 and can be stably reflowed during a reflow process. The reflowed polymer can be novolak, polystyrene, poly acrylic acid, poly vinyl, a combination thereof, or a photoresist including at least one of these substances. Although the surface protrusion 60 is illustrated as having a hemispherical shape in FIG. 5, various other shapes such as a horn shape, a tetrahedron pole, etc., can be implemented in alternative embodiments.

A biochip according to the fourth embodiment of the disclosed technology can increase the number of probes coupled to the surface protrusion 60 without an immobilization layer, thereby increasing the detection strength of a bio sample.

Although not shown in FIG. 5, a surface protrusion formed of reflowed polymer can include concaves and convexes on its surface (e.g., as illustrated in FIG. 4).

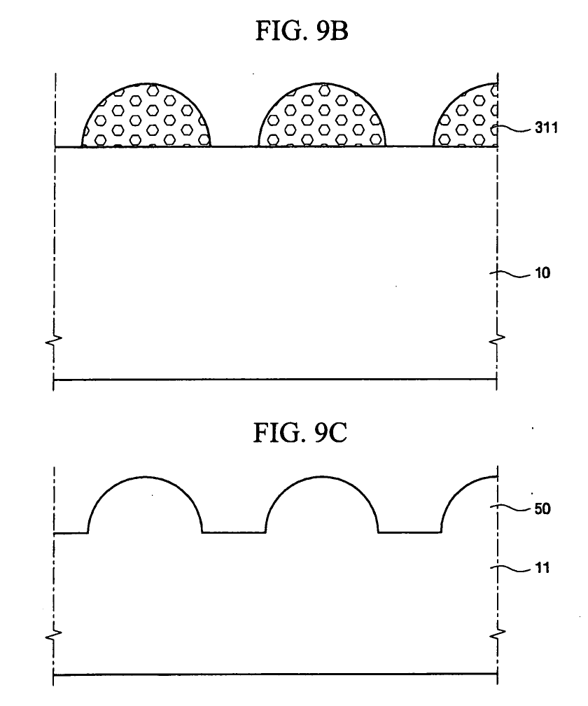

FIG. 6 is a cross-sectional view of a biochip according to a fifth embodiment of the disclosed technology.

Referring to FIG. 6, a biochip according to a fifth embodiment of the disclosed technology can include a substrate 15 having recess regions 70 and probes 200 coupled to each of the recess regions 70. The biochip can further include an immobilization layer 105 and/or a linker (not shown) that is formed on each of the recess regions 70 and can mediate coupling between the probes 200 and the substrate 15.

Each of the recess regions 70 of the substrate 15 can be formed in a probe cell region CR of the biochip. The immobilization layer 105 and/or the linker can be interposed between the probes 200 and the substrate 15 (e.g., in order to allow coupling of the probes 200). Each of the recess regions 70 can be formed by recessing the substrate 15 in various shapes such as a horn shape, a hexahedron shape, a hemispherical shape, etc., and its surface can include convexes and concaves. Thus, relative to a biochip to which the same (or similar) design rule is applied, a greater number of probes 200 can be coupled to the substrate 15 via an increase of an area to which the probes 200 can be coupled, thereby increasing the detection strength of a bio sample.

In the example, the immobilization layer 105 is conformally formed on each of the recess regions 70, and the probes 200 are coupled to the immobilization layer 105. The immobilization layer 105 and the probes 200 may be directly coupled to each other without a medium therebetween, or they may be indirectly coupled to each other via a linker as a medium therebetween.

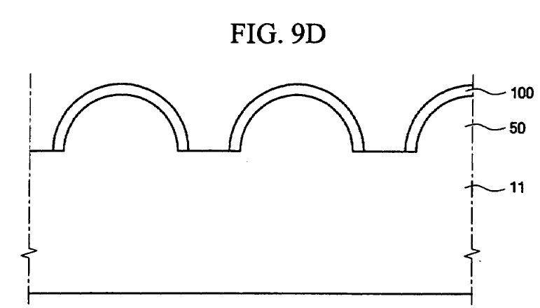

FIG. 7 is a cross-sectional view of a biochip according to a sixth embodiment of the disclosed technology.

Referring to FIG. 7, a biochip according to a sixth embodiment of the disclosed technology is different from a biochip according to the fifth embodiment of the disclosed technology in that an inactive region 106b of an immobilization layer 106 is formed on the surface of a non-probe cell region NCR. An active region 106a and the inactive region 106b of the immobilization layer 106 are similar to the active region 102a and inactive region 102b of the immobilization layer 102 illustrated in FIG. 3, which are described above. Thus, the active region 106a and inactive region 106b of the immobilization layer 106 will not be described in detail here.

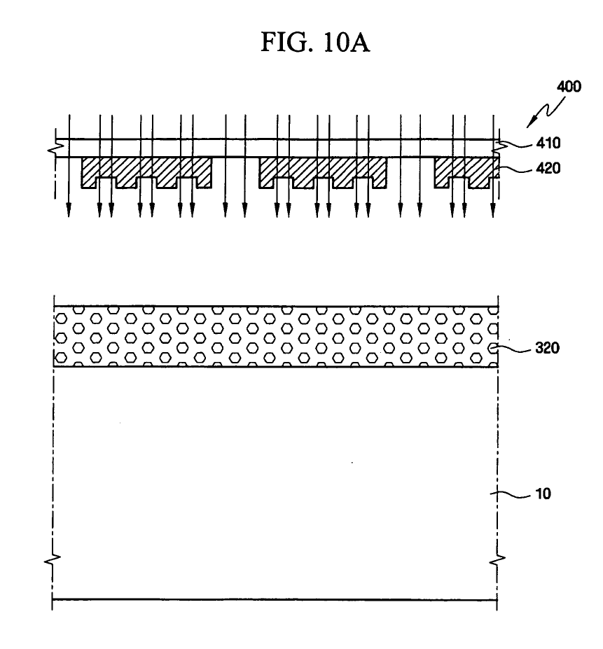

FIG. 8 is a cross-sectional view of a biochip according to a seventh embodiment of the disclosed technology.

Referring to FIG. 8, a biochip according to a seventh embodiment of the disclosed technology includes a substrate 17 having recess regions 75, immobilization layers 107 conformally formed on the recess regions 75, and probes 200 coupled onto each of the immobilization layers 107. The biochip is divided into probe cell regions CR, to which the probes 200 are coupled, and non-probe cell regions NCR, to which the probes 200 are not coupled. The recess regions 75 are formed only in the probe cell regions CR, and the surfaces of the non-probe cell regions NCR correspond to an exposed surface of the substrate 17.

Each of the recess regions 75 can have a hemispherical shape. In a biochip to which the same or similar design rule is applied, the recess region 75 having a hemispherical shape can increase an area to which the probes 200 can be coupled relative to a recess region in a polyhedron shape. Thus, the number of probes 200 coupled to each probe cell region CR can be increased, thereby improving detection strength despite a reduction in the design rule.

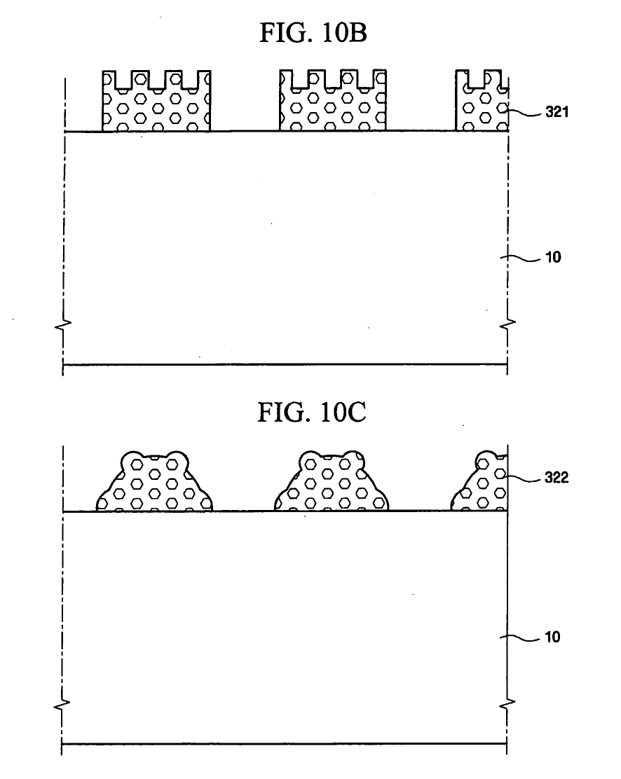

Hereinafter, a method of fabricating a biochip according to the embodiments of the disclosed technology will be described with reference to FIGS. 9A through 11C.

FIGS. 9A through 9D are cross-sectional views of structures in interim processing stages for explaining a method of fabricating the biochip illustrated in FIG. 2 according to the first embodiment of the disclosed technology.

Referring to FIG. 9A, photoresist patterns 310 are formed on areas of a substrate 10 where surface protrusions (e.g., the surface protrusions 50 of FIG. 2) are to be formed. The photoresist patterns 310 can be formed, for example, by forming a photoresist film on the substrate 10 and performing exposure and development with the use of a mask having a surface protrusion pattern reflected thereinto.

Referring to FIG. 9B, reflowed photoresist patterns 311 are formed on the substrate 10 by performing a reflow process on the photoresist patterns 310. The process temperatures and process times of the reflow process may be varied according to the thickness of the photoresist patterns 310 and the desired flexture degree of the reflowed photoresist patterns 311.

Referring to FIG. 9C, after formation of the reflowed photoresist patterns 311, the substrate 10 and the reflowed photoresist patterns 311 are etched together in order to form a substrate 11 including surface protrusions 50. The etching can be anisotropic etching, such as etch-back.

Next, the reflowed photoresist patterns 311 remaining on the substrate 11 including the surface protrusions 50 can be removed by using, for example, a strip process.

Referring to FIG. 9D, an immobilization layer 100 is formed on each of the surface protrusions 50. The immobilization layer 100 may be formed by forming and then patterning an immobilization layer forming film on the substrate 11 and the surface protrusions 50.

By coupling probes to the immobilization layer 100, a biochip as illustrated in FIG. 2 can be completed. Coupling of the probes can be performed by, for example, spotting the completed probes or synthesizing a probe monomer (e.g., a nucleotide phosphor amidite monomer whose functional group is protected by a photolytic group) via photolithography.

Although not shown in FIGS. 9A through 9D, coupling of the probes onto the immobilization layer 100 can include forming a linker on the immobilization layer 100 and coupling the probes to the linker.

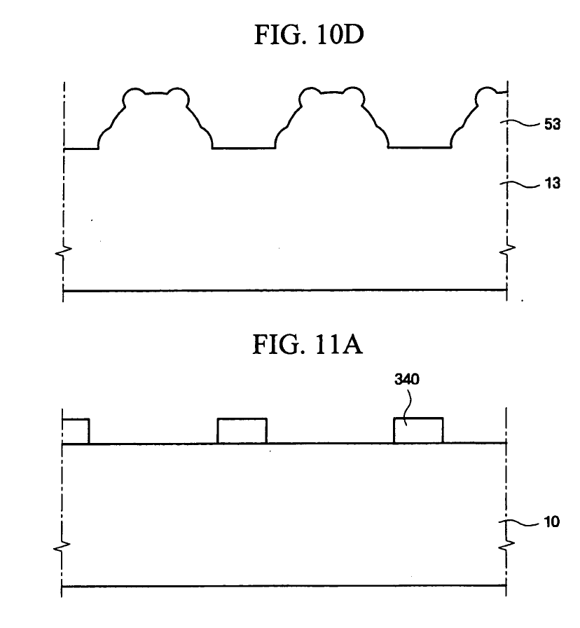

FIGS. 10A through 10D are cross-sectional views of structures in interim processing stages for explaining a method of fabricating the biochip illustrated in FIG. 4 according to the third embodiment of the disclosed technology.

Referring to FIG. 10A, a photoresist film 320 is formed on the substrate 10. The photoresist film 320 is then exposed by using a semi-permeable mask 400 having formed therein a semi-permeable pattern 420, which reflects both surface protrusion patterns, and convex and concave patterns on a transparent substrate 410.

Referring to FIG. 10B, photoresist patterns 321 having convex and concave patterns on their surfaces are formed on the substrate 10 by developing the exposed photoresist film 320.

Referring to FIG. 10C, a reflow process is performed on the photoresist patterns 321 in order to form reflowed photoresist patterns 322 on the substrate 10, thereby forming the photoresist patterns 322 which are reflowed into hemispherical shapes and include convexes and concaves on their surfaces (e.g., as illustrated in FIG. 9B).

Referring to FIG. 10D, the substrate 10 and the reflowed photoresist patterns 322 are etched together, forming a substrate 13 including surface protrusions 53 having convexes and concaves on their surfaces. The etching can be anisotropic etching, such as etch-back. The reflowed photoresist patterns 322 remaining on a substrate 13 including the surface protrusions 53 can then be removed.

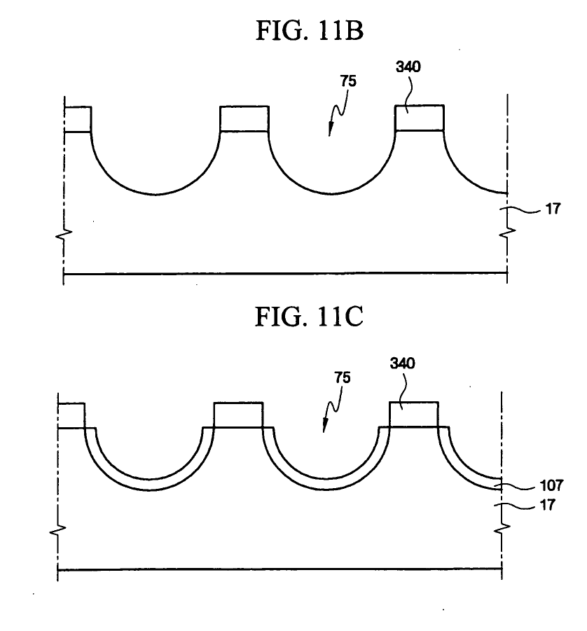

FIGS. 11A through 11C are cross-sectional views of structures in interim processing stages for explaining a method of fabricating the biochip illustrated in FIG. 8 according to the seventh embodiment of the disclosed technology.

Referring to FIG. 11A, a mask 340 for defining recess regions 75 is formed on the substrate 10. More specifically, the mask 340 can be formed on the substrate 10 corresponding to non-probe cell regions NCR of a biochip. The mask 340 can be an oxide mask, a nitride mask, a photoresist mask, etc.

Referring to FIG. 11B, isotropic etching can be performed on the substrate 10 in order to form the recess regions 75 with hemispherical shapes. For isotropic etching of the substrate 10, etching gas such as SF6 gas may be used.

Referring to FIG. 11C, after the recess regions 75 having hemispherical shapes are formed in a substrate 17, immobilization layers 107 are conformally formed in the recess regions 75.

In certain embodiments, the immobilization layers 107 can be made of a silicon oxide layer (such as a plasma enhanced-TEOS (PE-TEOS) layer, a high density plasma (HDP) oxide layer, a P—SiH4 oxide layer or a thermal oxide layer), silicate (such as hafnium silicate or zirconium silicate), a silicon nitride layer, a silicon oxynitride layer, a metal oxynitride layer (such as a hafnium oxynitride layer or a zirconium oxynitride layer), a metal oxide layer (such as a titanium oxide layer, a tantalum oxide layer, an aluminum oxide layer, a hafnium oxide layer, a zirconium oxide layer or an indium tin oxide (ITO) layer), a polyimide, a polyamine, a metal (such as gold, silver, copper or palladium), or a polymer (such as polystyrene, polyacrylate or polyvinyl).

In certain embodiments where the immobilization layer 107 is silicon oxide, a thermal oxide film can be formed by a thermal process, or silicon oxide can be formed by using chemical vapor deposition (CVD), sub-atmospheric pressure CVD (SACVD), low pressure CVD (LPCVD), plasma-enhanced CVD (PECVD), physical vapor deposition (PVD), etc.

The mask 340 can then be removed and the probes 200 can be coupled onto the immobilization layers 107, thereby completing a biochip (e.g., as illustrated in FIG. 8).

A method of fabricating a biochip according to an embodiment illustrated in FIGS. 11A through 11C can include forming the recess regions 75 within the substrate 17 by using a single mask, and forming the immobilization layers 107 for mediating coupling between the probes and the substrate 17, thereby removing a need to form a separate mask at each stage and thus improving processing efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims. The invention generally describes methods for increasing the surface area within probe cell regions one which are formed probes. The surface area is increased by forming projections on, or recesses in, the substrate surface. The greater the surface area, generally the greater number of probes may be attached to that surface. The detection strength of the biochip may therefore be increased. It is therefore desired that the present embodiments be considered in all respects as illustrative and not restrictive, reference being made to the appended claims to indicate the scope of the invention.

What is claimed is:

1. A biochip comprising:
a substrate;
a plurality of surface features formed on the substrate; and
a plurality of probes coupled to each of the plurality of surface features, wherein the surface features are protrusions from or recesses in the substrate.

2. The biochip of claim 1, wherein the plurality of surface features and the substrate are integrally formed.

3. The biochip of claim 2, wherein each of the plurality of surface features have substantially hemispherical shapes.

4. The biochip of claim 2, wherein a surface of each of the plurality of surface features includes a plurality of convex and a plurality of concave portions.

5. The biochip of claim 2, further comprising an immobilization layer conformally formed on each of the plurality of surface features, wherein the plurality of probes are coupled to the immobilization layer.

6. The biochip of claim 2, wherein the biochip further comprises:
a plurality of probe cell regions, wherein the plurality of probes are coupled to the plurality of probe cell regions; and
a plurality of adjacent non-probe cell regions to which the probes are not coupled.

7. The biochip of claim 6, wherein the plurality of surface features are formed in the plurality of probe cell regions, and wherein the surface features project or recess to a different elevation than the adjacent non-probe cell regions.

8. The biochip of claim 1, wherein the surface features are surface protrusions and each of the plurality of surface protrusions comprises reflowed polymer.

9. The biochip of claim 8, wherein each of the plurality of surface protrusions has a substantially hemispherical shape.

10. The biochip of claim 8, wherein a surface of each of the plurality of surface protrusions comprises a plurality of convexes and a plurality of concaves.

11. The biochip of claim 8, wherein the biochip further comprises:
a plurality of probe cell regions, wherein the plurality of probes are coupled to the plurality of probe cell regions; and
a plurality of non-probe cell regions to which the probes are not coupled.

12. The biochip of claim 11, wherein the plurality of surface protrusions are formed in the plurality of probe cell regions, and wherein the surface protrusions project to a different elevation than the adjacent non-probe cell regions.

13. A biochip comprising:
a substrate having a plurality of surface features projecting from or recessing into a planar elevation of the substrate surface; and
a plurality of probes coupled to each of the plurality of surface features, wherein a surface of each of the plurality of surface features comprises a plurality of convexes and a plurality of concaves.

14. The biochip of claim 13, further comprising an immobilization layer conformally formed in each of the plurality of surface features, wherein the plurality of probes are coupled to the immobilization layer.

15. The biochip of claim 13, wherein the biochip further comprises:
a plurality of probe cell regions, wherein the plurality of probes are coupled to the plurality of probe cell regions, and wherein the plurality of surface features are formed in the plurality of probe cell regions; and
a plurality of non-probe cell regions, wherein a surface of each of the plurality of non-probe cell regions comprises an exposed surface of the substrate.

16. A biochip comprising:
a substrate having a plurality of surface features comprising recess regions or projection regions;
a plurality of immobilization layers conformally formed on the plurality of surface features; and
a plurality of probes coupled onto each of the plurality of immobilization layers, wherein the biochip is divided into:
a plurality of probe cell regions, to which the plurality of probes are coupled, wherein the plurality of surface features are formed in the plurality of probe cell regions; and
a plurality of non-probe cell regions, wherein a surface of each of the plurality of non-probe cell regions comprises an exposed surface of the substrate.

17. The biochip of claim 16, wherein each of the plurality of surface features has a substantially hemispherical shape.

18. The biochip of claim 16, wherein each of the plurality of immobilization layers comprises one of an oxide, a nitride, or a polymer.

19. The biochip of claim 16, wherein the surface features includes a plurality of recess regions formed into a surface of the substrate, and wherein the immobilization layers are conformally formed within the recess regions.

20. The biochip of claim 16, wherein the surface features includes a plurality of projection regions formed on a surface of the substrate, and wherein the immobilization layers are conformally formed on the projection regions.
